(19) United States
(12) Patent Application Publication
(10) Pub. No.: US 2021/0294026 A1
(43) Pub. Date: Sep. 23, 2021

(54) SINGLE-MODE OPTICAL FIBER HAVING NEGATIVE CHROMATIC DISPERSION

(71) Applicant: Panduit Corp., Tinley Park, IL (US)

(72) Inventors: Richard J. Pimpinella, Frankfort, IL (US); Jose M. Castro, Naperville, IL (US); Bulent Kose, Burr Ridge, IL (US); Asher S. Novick, Chicago, IL (US); Yu Huang, Orland Park, IL (US)

(73) Assignee: Panduit Corp., Tinley Park, IL (US)

(21) Appl. No.: 17/260,312

(22) PCT Filed: Jul. 11, 2019
(86) PCT No.: PCT/US2019/041338

§ 371 Date: Jan. 14, 2021

Related U.S. Application Data
(60) Provisional application No. 62/696,973, filed on Jul. 12, 2018.

(51) Int. Cl. G02B 6/02; H04B 10/2525

(52) U.S. Cl. CPC G02B 6/02252; H04B 10/2525

(57) ABSTRACT

A single-mode optical fiber that reduces the chromatic dispersion of an optical pulse due the laser chirp in an optical communication system operating in the O-band has a cable cutoff wavelength less than 1250 nm, a zero-dispersion wavelength greater than 1334 n, and a nominal mode field diameter of said fiber at 1310 nm between 8.6 and 9.5 microns.

### CROSS REFERENCE TO RELATED APPLICATION

This application claims priority to U.S. Provisional Application No. 62/696,973, filed Jul. 12, 2018, the subject matter of which is hereby incorporated by reference in its entirety.

### FIELD OF THE INVENTION

The invention generally relates to optical fibers and specifically to single mode optical fibers for reducing chromatic dispersion.

### BACKGROUND OF THE INVENTION

Today, the requirements for high-speed optical communications is primarily driven by the bandwidth demands of hyperscale data center networks, where channel reaches are short and range from 2 to 500 m. For data rates of 100 Gb/s and higher, the maximum channel reach over laser optimized OM4 or OM5 multimode fiber, as specified in IEEE 802.3 Ethernet Standards, is 100 m. Single-mode transceivers are specified to operate in the O-Band and support channel reaches of 2 km or 10 km, depending on the transceiver option. As the maximum channel reach of MMF continues to decrease, there is an increasing demand for low-cost short reach single-mode transceivers supporting reaches of only 500 m. The reduction in reach requirement enables tradeoffs in other parameters such as transmitter jitter, optical coupling efficiency, wavelength stability, and bandwidth.

For single-mode applications, high bandwidth transmission is achieved by multiplexing multiple channel wavelengths onto a single fiber strand utilizing wavelength division multiplexing (WDM). Channel plans vary, but a typical dense wavelength division multiplexing (DWDM) system utilizes 40 channels at 100 GHz spacing, or 80 channels with 50 GHz spacing. Coarse wavelength division multiplexing (CWDM) utilizes channel plans of 4 or 8 wavelengths with 20 nm channel spacing, but, can include up to 18 wavelengths between 1271 nm and 1611 nm±6-7 nm.

For short reach SMF applications utilizing only 4 or 8 wavelengths, cost can be reduced by relaxing wavelength requirements and eliminating components such as the thermal electric coolers (TECs) required to maintain tight wavelength control and stability for demultiplexing and Random Optical Add/Drop Modules (ROADM) applications. Since wavelength plans based on CWDM requirements have large channel spacings, transceivers do not require TECs (uncooled lasers) and are cheaper.

For data center channel reaches less than 500 m utilizing 4 or 8 discrete wavelengths in the 1310 nm window, wavelength stability, temperature control, coupling efficiency, and output power are not critical parameters. With new device technologies such as photonic integrated circuits and WDM filters, significant cost reductions can be realized, where single-mode transceiver cost can approach that of multimode pluggable modules.

Single-mode fiber was originally designed for 1310 nm Fabry Perot (FP) semiconductor lasers and therefore, the zero-dispersion wavelength (ZDW) of the optical fiber is specified in international Standards such as ITU 6.652 and G.657, to be 1310 nm±10 nm. Because FP lasers are manufactured by a high yield process, they are relatively low cost, but they emit multiple longitudinal modes and consequently, have a relatively wide spectral width as shown in FIG. 1(a). This broad signal linewidth results in a significantly large chromatic dispersion penalty.

Today, for high-speed WDM applications, distributed-feedback (DFB) semiconductor lasers are used, but the manufacturing process requires equipment-intensive grating fabrication and overgrowth deposition steps. The advantage of DFB laser however, is they emit a single-frequency pulse as shown in FIG. 1(b). The narrow linewidth results in low chromatic dispersion.

Although in principle DFB lasers are single-frequency devices, due to a phenomenon known as laser chirp, DFB lasers have a narrow but finite spectral width which increases the channel chromatic dispersion penalty, thereby contributing to the limitation in maximum channel reach. Laser chirp is the shift in output wavelength in response to a change in refractive index which occurs during transitions between optical output logic states. As the input signal drive current enters the laser cavity, the increase in charge density results in an increase in material refractive index, which in turn monotonically reduces the transmitted optical wavelength. Conversely, when the electrical drive signal decreases and the optical output transitions from a logic 1 to 0, there is a decrease in charge density and thus the refractive index, resulting in a monotonic increase in output wavelength.

Hence, for low-cost SMF transceivers, it is advantageous to optimize the optical channel performance by reducing one or more of the optical penalties introduced by the physical fiber medium to provide additional optical margin. In this disclosure, we describe a single-mode optical fiber with modified optical attributes in the O-band, that when coupled to single-mode laser transceivers in the 1310 nm operating wavelength window, the channel provides chromatic dispersion compensation due to laser chirp, and, reduced multi-path interference by reducing high-order mode generation at connector and transceiver interfaces.

### SUMMARY OF THE INVENTION

Disclosed is modifications to the optical waveguide attributes of SMF to make the fiber more compatible with low-cost, high-speed optical transceivers for short reach applications utilizing lasers in the 1310 nm window (O-band). Modifications to the SMF optical attributes include shifting the zero-dispersion wavelength (ZDW) to reduce chromatic dispersion due to laser chirp, and, shifting the cutoff wavelength (xc) to reduce multipath interference (MPI). Single-mode fibers in accordance with the present invention provide increased power margins for improved channel reliability and/or longer channel reach for transceivers operating in the 1310 nm window.

### BRIEF DESCRIPTION OF THE DRAWINGS

FIG. 1a shows a Fabry Perot laser spectrum showing multiple longitudinal nodes

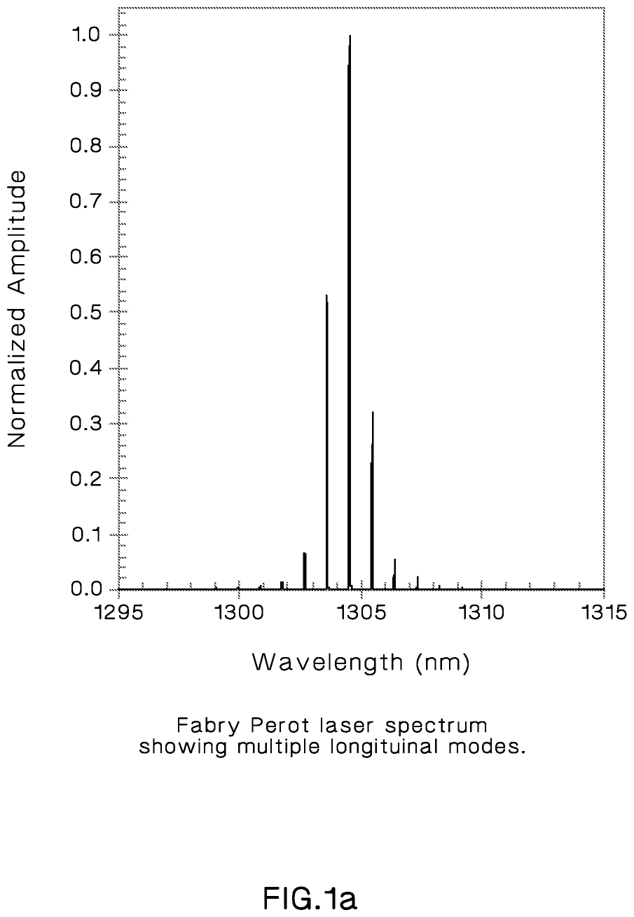

FIG. 1b shows a distributed feedback laser narrow linewidth spectrum.

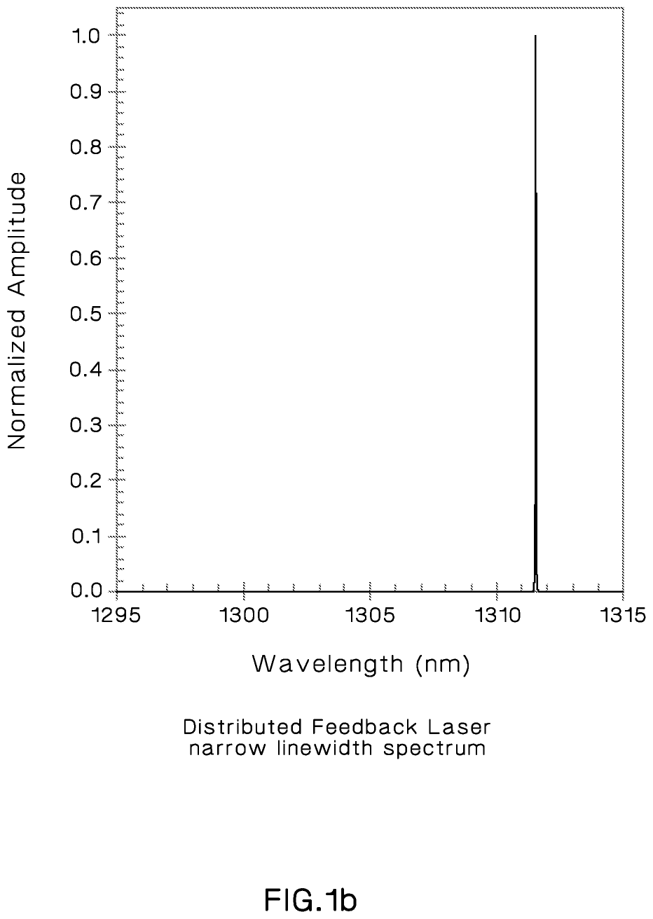

FIG. 2 shows IEEE 802.3 Ethernet SMF Wavelength Grids.

FIG. 3 is a graph showing pulse delay as a function of wavelength.

FIG. 4 shows a plot of the chromatic dispersion of a typical SMF over the wavelength range of 1250 nm to 1370 nm.

FIG. 5 shows the plot of a SMF with a shifted zero dispersion wavelength.

FIG. 6 is a plot showing the relationship between multi-path interference and cutoff wavelength.

### DETAILED DESCRIPTION OF THE INVENTION

An optical fiber in accordance to the present invention has a zero-dispersion wavelength shifted to a longer wavelength compared to industry Standards unshifted single-mode fiber Types IT U-G.652, and/or IT U-G.657, where the ZDW is specified to be between 1302 nm and 1322 nm. A fiber compliant with the present invention has a ZDW greater than 1334 rnm, so that essentially all transmitted operating wavelengths in the 1310 nm window undergo a negative chromatic dispersion when propagating through said optical SMF channel. A negative dispersion compensates for the chromatic dispersion due to laser chirp, thereby reducing the signal pulse-width and hence, the dispersion penalty of the channel.

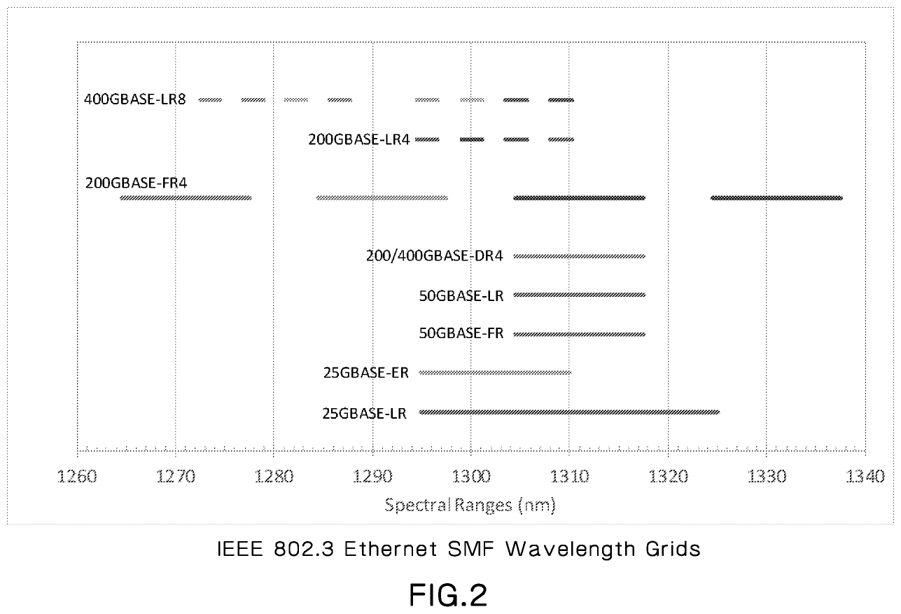

In FIG. 2, we plot the spectral grids and wavelength ranges for 8 SMF laser transceiver options specified in IEEE 802.3 Ethernet Standards for data rates ranging from 25 Gb/s to 400 Gb/s. Transceivers can include 1, 4, or 8 discrete signal wavelengths. For these Ethernet specified transceivers, the maximum operating wavelength is 1337.5 nn, which is utilized in the 200GBASE-FR4 transceiver. We can calculate the required ZDW that would provide a negative dispersion for all transceivers shown in FIG. 2, as follows.

The chromatic dispersion is caused by the wavelength dependence of the optical fiber and includes two components, material dispersion given by,

dn₁/dλ≠0

where n₁ is the core refractive index, and profile (or waveguide) dispersion given by,

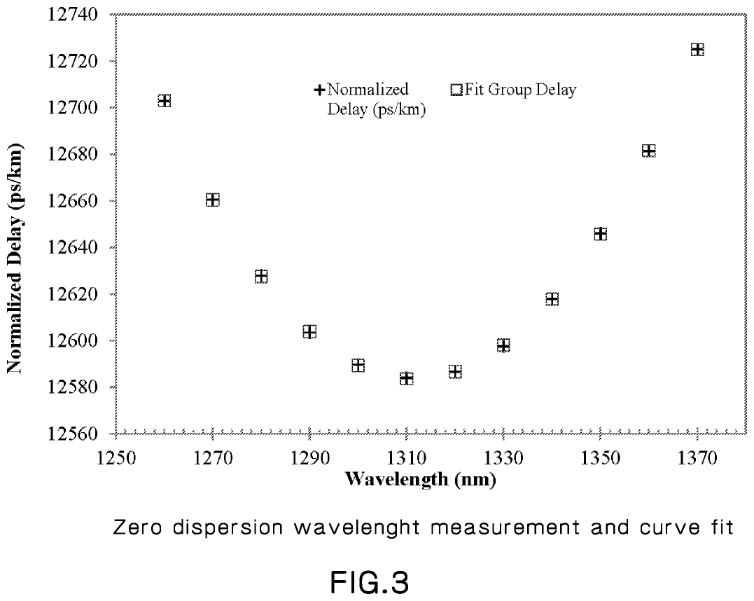

dΔ/dλ≠0

where, Δ is the ratio between the core radius and wavelength. We can compute the dispersion by numerically fitting pulse delay data as a function of wavelength as shown in FIG. 3, using the following least-mean-square-error criterion,

τ(λ)=A+Bλ²+Cλ².

where, τ(λ) is the spectral group delay as a function of wavelength and A, B, and C are fitted parameters.

The chromatic dispersion coefficient D(λ), is defined as,

$$D ( λ ) ≡ \frac{d τ}{d λ}$$

$$Hence , D ( λ ) = \frac{d}{d λ} τ ( λ ) = 2 ( B λ - C {λ}^{- 3} )$$

Using the fitted parameters B and C, we can compute the “zero-dispersion wavelength,” λ₀, where, D(λ)=0.

$${λ}_{0} = {( \frac{C}{B} )}^{1 / 4}$$

Solving for the parameter C in terms of λ₀ we get,

C=Bλ₀⁴

The dispersion slope, S(λ), is the first derivative of the dispersion with respect to wavelength, i.e.,

$$S ( λ ) = \frac{d}{d λ} D ( λ ) = \frac{d}{d λ} [ 2 ( B λ - C {λ}^{- 3} ) ] = 2 B + 6 C {λ}^{- 4}$$

At the zero-dispersion wavelength, the dispersion slope is represented by S₀, hence,

$${S}_{0} = S ( {λ}_{0} ) = 8 B And , B = \frac{{S}_{0}}{8}$$

rewriting D(λ) in terms of λ₀ and S₀, we get for the dispersion:

$$D ( λ ) = \frac{{S}_{0}}{4} λ ( 1 - \frac{{λ}_{0}^{4}}{{λ}^{4}} )$$

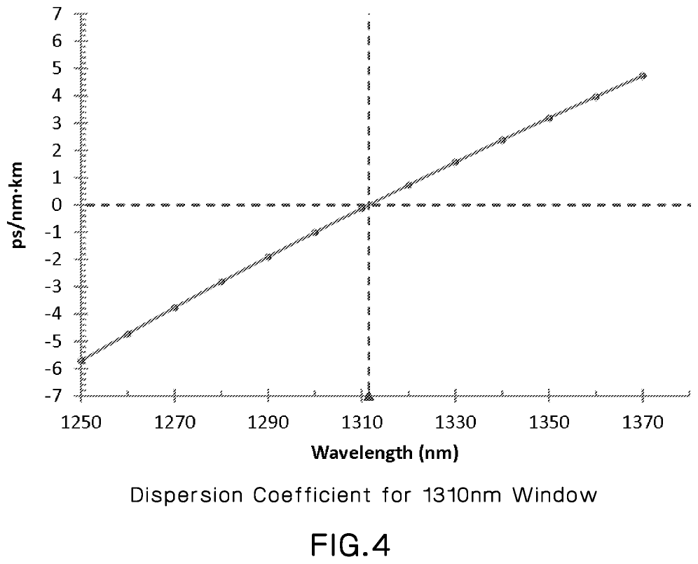

In FIG. 4, we plot the chromatic dispersion for the exemplary ITl-G652D SMF over the wavelength range of 1250 nm to 1370 nm.

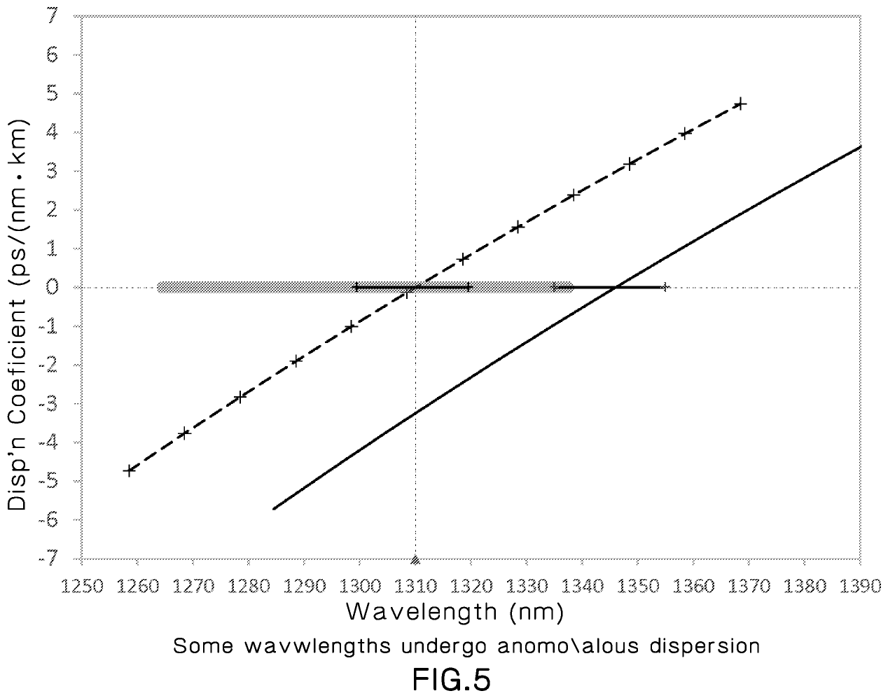

For a nominal Standards compliant SMF with a specified ZDW between 1302 mu and 1322 nm, analysis shows a positive dispersion coefficient for wavelengths longer than 1310 nm, and consequently, dispersion due to laser chirp is exacerbated. By shifting the dispersion curve, as shown in FIG. 5, so that the ZDW is approximately 1340 nm, all transceiver wavelengths (illustrated by the green horizontal line) will experience a negative dispersion coefficient thereby compensating for chirp.

According to the present invention, said SMF has a ZDW greater than 1334 nm so that all optical transmission signals for a given applications such as IEEE 802.3 Ethernet, undergo a negative chromatic dispersion to compensate for laser chirp. Hence, the ZDW of said fiber for this application, where the maximum wavelength is 1337.5 nm, should be greater than 1347.5 nm with a tolerance of ±10 nm, typical of current industry standards limits for SMF.

A second optical penalty in single-mode channels containing short fiber segments, such as patch cords, is coherent multi-path interference (MPI). MPI results when an optical pulse travels to the detector via two or more optical paths. Under these conditions, the wave components arrive at the receiver detector with a relative phase shift and consequently result in destructively interfere at the receiver detector causing signal noise. Spectral loss measurements in single-mode fiber show a correspondence between MPI and fiber cutoff wavelength, where for high cutoff, the generation of higher order fiber modes (HOM) increase the channel MPI. A fiber with a specific core diameter D, transmits light in a single-mode only at the wavelengths longer than the cutoff wavelength λ_{c}, given by,

$${λ}_{c} = \frac{π D \sqrt{{n}_{0}^{2} - {n}_{1}^{2}}}{2.4}$$

where n₀ is the core refractive index, and n₁ is the cladding refractive index.

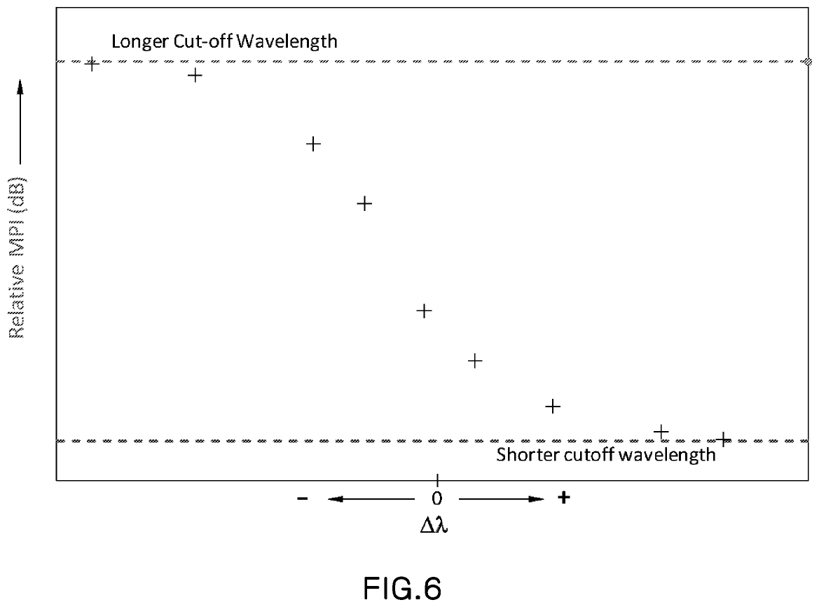

In FIG. 6, we plot empirical data showing the relationship between cutoff wavelength and MPI, where for a given operating wavelength the MPI is higher for longer cutoff wavelengths. For a fiber of diameter D having a cutoff close to the operating wavelength, the MPI is within the transition region between the two extreme conditions shown in FIG. 6, where there is roughly a linear relation between cutoff wavelength and MPL, Using this data, we can relate MPI to the difference Δλ between the operating wavelength λ and cutoff λ_{c}, where,

$$Δ λ = ( λ - {λ}_{c} )$$

$$and , \\ MPI ∝ \frac{1}{Δ λ}$$

Hence, empirical data shows MPI be reduced with a shorter cutoff for O-Band Ethernet applications.

1. A single-mode optical fiber that reduces the chromatic dispersion of an optical pulse due the laser chirp in an optical communication system operating in the O-band, wherein properties of the fiber comprise:
a cable cutoff wavelength less than 1250 nm;
a zero-dispersion wavelength greater than 1334 nm;
a nominal mode field diameter of said fiber at 1310 nm between 8.6 and 9.5 microns.

2. A single-mode fiber according to claim 1, wherein a chromatic dispersion is negative for all transceiver operating wavelengths in the optical communications O-band.

3. A fiber according to claim 1, wherein the cutoff wavelength reduces high order modes in said single-mode fiber, so that coherent multipath interference at an optical interface is reduced.

4. A cable comprising at least one single-mode optical fiber according to claim 1.

5. A single-mode optical fiber that minimizes inter-symbol interference and coherent multipath interference penalties in the 1310 nm operating window using directly modulated semiconductor lasers.
